(19) United States
(12) Patent Application Publication
(10) Pub. No.: US 2015/0233757 A1
(43) Pub. Date: Aug. 20, 2015

(54) VIBRATION EXPOSURE MONITORING SYSTEM

(71) Applicant: Milwaukee Electric Tool Corporation, Brookfield, WI (US)

(72) Inventor: Jeremy R. Ebner, Milwaukee, WI (US)

(21) Appl. No.: 14/626,613

(22) Filed: Feb. 19, 2015

Related U.S. Application Data
(60) Provisional application No. 61/942,259, filed on Feb. 20, 2014.

(51) Int. Cl. G01H 1/00

(52) U.S. Cl. CPC G01H 1/00

(57) ABSTRACT

A vibration exposure monitoring system, for use in a power tool, includes a controller operable to log an amount of time that the power tool is in use for different users throughout a duration of a predetermined time period and an indicator for providing a signal to one of the users of the power tool when the amount of time for the one of the users exceeds a predetermined threshold.

### CROSS-REFERENCE TO RELATED APPLICATIONS

This application claims priority to U.S. Provisional Patent Application No. 61/942,259 filed Feb. 20, 2014, the entire content of which is hereby incorporated by reference.

### FIELD OF THE INVENTION

The present invention relates to power tools, and more particularly to vibrating power tools.

### BACKGROUND OF THE INVENTION

The operation of certain power tools can expose a user to different levels of vibration while performing various tasks. Exposure to vibration for prolonged periods of time can have negative effects on the health of an individual. Therefore, individuals using such vibration-emitting power tools would benefit from intermittent periods of rest or knowing when they have exceeded a recommended daily level of vibration exposure so that they may discontinue use of the power tool for the day.

### SUMMARY OF THE INVENTION

The invention provides, in one aspect, a vibration exposure monitoring system for use in a power tool. The system includes a controller operable to log an amount of time that the power tool is in use for different users throughout a duration of a predetermined time period and an indicator for providing a signal to one of the users of the power tool when the amount of time for the one of the users exceeds a predetermined threshold.

The invention provides, in another aspect, a method of monitoring vibration exposure during use of a power tool. The method includes logging an amount of time the power tool is in use for different users throughout a duration of a predetermined time period and signaling one of the users of the power tool when the amount of time associated with the user exceeds a predetermined threshold.

Other features and aspects of the invention will become apparent by consideration of the following detailed description and accompanying drawings.

### BRIEF DESCRIPTION OF THE DRAWINGS

FIG. 1 is a perspective view of a rotary impact power tool including a vibration exposure monitoring system of the invention.

FIG. 2 is a graph of various vibration exposure levels, illustrating vibration magnitude as a function of exposure duration.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

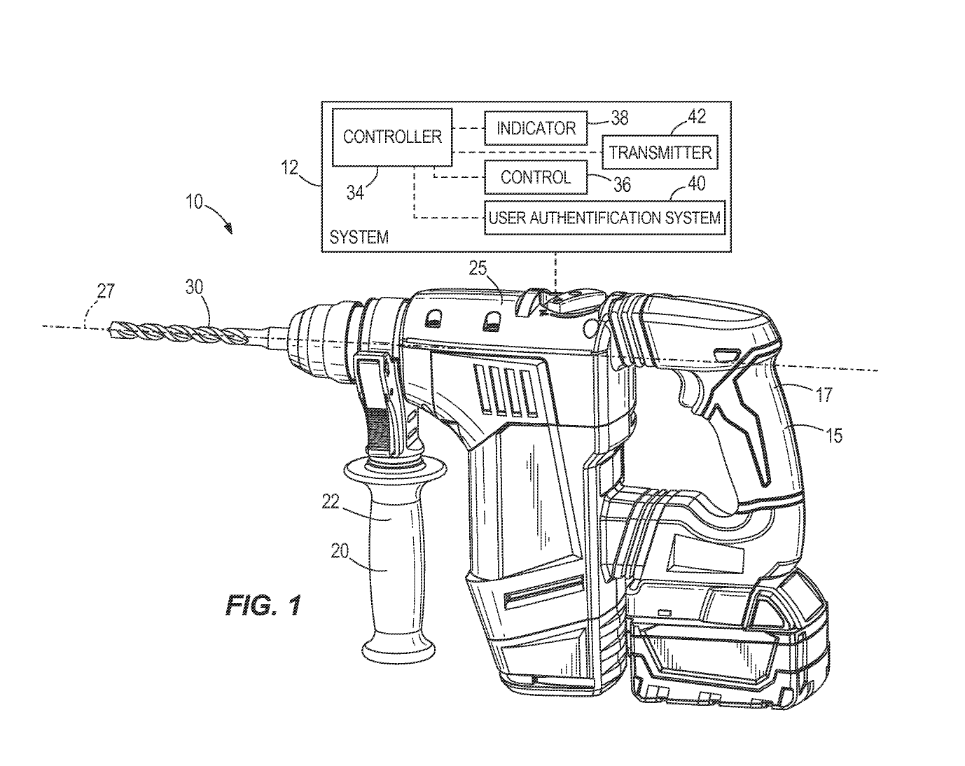

FIG. 1 illustrates a rotary impact power tool 10 including a vibration exposure monitoring system 12. As described in further detail below, the system 12 communicates to the user of the tool 10 whether or not a particular vibration exposure level relative a predetermined time period has been exceeded. As shown in FIG. 1, the power tool 10 is illustrated as a rotary hammer, but other power tools (e.g., impact drivers, impact wrenches, hammer drills, grinders, jackhammers, etc.) may include the system 12. The power tool 10 includes a housing 25, a motor and transmission (not shown) within the housing 25 for providing torque to a tool element 30 (e.g., a drill bit), and an impact mechanism (also not shown) within the housing 25 for providing repeated axial impacts to the tool element 30. The housing 25 includes a main handle 15 formed as part of the housing 25 and oriented at an oblique angle relative to a longitudinal axis 27of the housing 25. Alternatively, the main handle 15 may be formed substantially perpendicular to the longitudinal axis 27 of the housing 25. The power tool 10 also includes an auxiliary handle 20 removably coupled to the housing 25 for providing additional support of the power tool 10 during operation. The auxiliary handle 20 may be adjusted about the longitudinal axis 27 of the housing 25 and positioned in an orientation most comfortable to a user for a specific task. Alternatively, the auxiliary handle 20 may be permanently fixed to the housing 25.

With continued reference to FIG. 1, the system 12 includes a controller 34 and an indicator 38 in communication with the controller 34 for providing a visual signal, an audio signal, or a combination visual and audio signal to the user of the power tool 10 at appropriate times during use of the power tool 10 as discussed below. The controller 34 is also in communication with a master-level controller (not shown) of the power tool 10 for logging an amount of time that the power tool 10 is in use throughout the duration of a predetermined time period (e.g., 24 hours).

In operation, the system 12 monitors the vibration a user is exposed to during operation of the power tool 10 for a predetermined time period (e.g., 24 hours). The vibration experienced by the user is monitored with reference to a primary handle location 17 and an auxiliary handle location 22. The testing methods used to characterize the vibration of the power tool 10 are per the requirements of standards EN 60745-1, EN 60745-2, EN ISO 5349-1, and EN ISO 53495-2, the contents of which are hereby incorporated by reference. The overall vibration of the power tool 10 is characterized as the higher of the vibrations recorded at the primary handle location 17 and the auxiliary handle location 22. A reference vibration value, A(8), is calculated using the following equation per the standards above.

$$A ( 8 ) = {a}_{hv} * \sqrt{\frac{T}{{T}_{o}}}$$

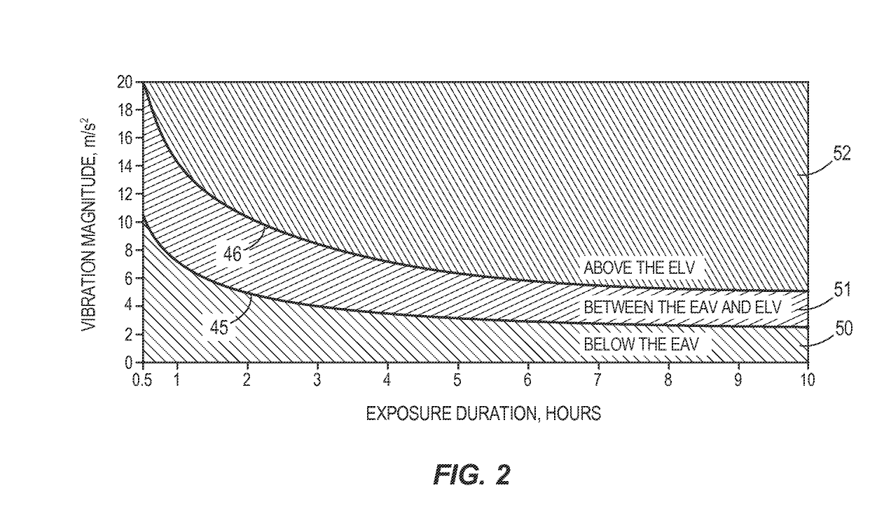

“aₕᵥ” is the measured hand-arm weighted vibration of the power tool 10 and is a constant provided by the manufacturer of the power tool 10 or determined using the testing methods described above. “T” represents the total daily duration of exposure to the vibration aₕᵥ, while “T₀” is a reference duration of eight hours. The calculated A(8) value is compared to two thresholds 45, 46. Specifically, the first threshold 45 may be assigned an A(8) value of 2.5 m/s² and may otherwise be known as the “Exposure Active Value (EAV),” and the second threshold 46 may be assigned an A(8) value of 5.0 m/s² and may otherwise be known as the “Exposure Limit Value (ELV).” FIG. 2 illustrates exposure duration (i.e., “T”) versus vibration magnitude (i.e., “aₕᵥ”), and the curves coinciding with the respective thresholds 45, 46 are representative of the EAV and ELV values, respectively. As discussed in more detail below, for known values of A(8) and for a known value of aₕᵥ for a particular power tool 10, the system 12 can calculate the exposure duration T for the EAV and ELV values. Furthermore, the system 12 can determine whether a user is operating the power tool 10 beyond either of the EAV or ELV values coinciding with the thresholds 45, 46, respectively, in FIG. 2 by logging the usage time of the power tool 10 over a given period of time and comparing the value of the logged usage time with the calculated values of EAV and ELV.

As illustrated in FIG. 2, the system 12 references vibration exposure with respect to three exposure levels 50, 51, 52 defined by the first threshold 45 and the second threshold 46. Alternatively, more or fewer than three exposure levels could be referenced by the system. In the first exposure level 50, a user is operating a power tool below the EAV value (i.e., below both the first and second thresholds 45, 46) and has been exposed to substantially no health risks. In the second exposure level 51, a user is operating a power tool between the EAV and ELV values (i.e., above the first threshold 45 and below the second threshold 46) and has experienced a moderate amount of vibration for a reference period of 8 hours. The user should stop operation of the power tool 10 if possible while in the second exposure level 51. In a third exposure level 52, a user is operating a power tool above the ELV value (i.e., above the second threshold 46) and has been exposed to a potentially hazardous amount of vibration for a reference period of 8 hours. The user should stop operation of the power tool 10 immediately if within the third exposure level 52.

In operation of the power tool 10 with the system 12, the indicator 38 signals to the user in which exposure level 50, 51, 52 the user is operating the power tool 10 to warn them of potentially hazardous use. The indicator 38 may provide a visual signal that displays to the user the current exposure level 50, 51, 52. More specifically, the indicator 38 may include one or more LEDs for communicating the different exposure levels 50, 51, 52. For example, the LEDs could flash or continuously illuminate green while the user is operating the power tool 10 within the first exposure level 50, yellow while the user is operating the power tool 10 within the second exposure level 51, and red while the user is operating the power tool 10 within the third exposure level 52. Alternatively, three separate LEDs may be provided, a first of the LEDs being illuminated (e.g., in green) when the user is operating the power tool 10 within the first exposure level 50, a second of the LEDs being illuminated (e.g., in yellow) when the user is operating the power tool 10 within the second exposure level 51, and a third of the LEDs being illuminated (e.g., in red) when the user is operating the power tool 10 within the third exposure level 52.

The indicator 38 could also include an audio signal that communicates to the user that they have transitioned from one exposure level to another. As a further alternative, the indicator 38 could include both visual and audio signals to communicate to the user that they have transitioned from one exposure level to another. In other embodiments of the power tool 10, the controller 34 may calculate and display an instantaneous ISO vibration number (e.g., an A(8) value) on the indicator 38, which could be a visual display on the power tool 10. Alternatively, the controller 34 may calculate and the indicator 38 may display remaining operating times for the power tool 10 before reaching the EAV value, the ELV value, or both.

After use of the power tool 10 has transitioned into the third exposure level 52, the system 12 may deactivate the power tool 10 to prevent the user from being exposed to further vibration. The system may also include a control 36 such as, for example, a button or wireless controller for manually resetting the recorded vibration exposure for a given time period. Alternatively, the system 12 may automatically reset daily at a predetermined time. The system 12 may also include a plurality of user profiles so that a plurality of users may use the power tool 10 at any given time so that the vibration exposure of each user is accounted for individually. To prevent a user from simply switching user profiles to continue use of the power tool 10 after they have reached the third exposure level 52, the system 12 may include a user authentication system 40 to verify the identity of the user. Such an authentication system may include a keypad, for example, for allowing a user to enter a passcode. Alternatively, the system may not deactivate the power tool upon reaching the third exposure level 52, but rather is used for informational purposes only.

With reference to FIG. 2, when a user begins using the power tool 10, the indicator 38 will initially display that the user is in the first exposure level 50 in one of the manners described above. Once the usage time logged by the system 12 exceeds the calculated exposure duration T coinciding with the EAV value (and the threshold 45), the indicator 38 signals to the user that they are now operating the power tool 10 within the second exposure level 51. For example, for a power tool 10 having a value for “aₕᵥ” of 6 m/s², the power tool 10 can be used for approximately 1.4 hours before reaching the second exposure level 51. After further use, once the usage time logged by the system 12 exceeds the calculated exposure duration T coinciding with the ELV value (and the threshold 46), the indicator 38 signals to the user that they are now operating the power tool 10 within the third exposure level 52. For the same power tool 10 having a value for “aₕᵥ” of 6 m/s², the power tool 10 can be used for approximately 5.5 hours before reaching the third exposure level. Upon reaching the third exposure level 52, the user should discontinue using the power tool 10 for the day.

The system 12 may also include a transmitter 42 incorporated with or otherwise operated by the controller 34 for transmitting usage time of the power tool 10 to a smart device (e.g., a smart phone, tablet, etc.) or computer database for logging the usage time in a similar manner as the on-board system 12 described above, thereby permitting remote or offsite monitoring of vibration exposure to individuals using the power tool 10.

Various features and advantages of the invention are set forth in the following claims.

What is claimed is:

1. A vibration exposure monitoring system for use in a power tool, the system comprising:
a controller operable to log an amount of time that the power tool is in use for different users throughout a duration of a predetermined time period; and
an indicator for providing a signal to one of the users of the power tool when the amount of time for the one of the users exceeds a predetermined threshold.

2. The vibration exposure monitoring system of claim 1, wherein the amount of time that the power tool is in use is related to the amount of vibration exposure experienced by the users of the power tool.

3. The vibration exposure monitoring system of claim 1, wherein the signal is a visual signal or an audio signal.

4. The vibration exposure monitoring system of claim 1, wherein the signal corresponds to a transition from a first vibration exposure level to a second vibration exposure level.

5. The vibration exposure monitoring system of claim 4, wherein the signal is a first signal and the predetermined threshold is a first predetermined threshold, and wherein the indicator is configured to further provide a second signal to the user of the power tool when the amount of time exceeds a second predetermined threshold greater than the first predetermined threshold.

6. The vibration exposure monitoring system of claim 5, wherein the second signal corresponds to a transition from the second vibration exposure level to a third vibration exposure level.

7. The vibration exposure monitoring system of claim 5, wherein the indicator includes a light, wherein the first signal is representative of the light changing from a first color to a second color, and wherein the second signal is representative of the light changing from the second color to a third color.

8. The vibration exposure monitoring system of claim 5, wherein the indicator displays a remaining operating time of the power tool by one of the users before at least one of the first or second predetermined thresholds are reached.

9. The vibration exposure monitoring system of claim 5, wherein the system is operable to deactivate the power tool upon reaching the second predetermined threshold.

10. The vibration exposure monitoring system of claim 1, wherein the system includes a control for manually resetting a usage time for one or more of the users.

11. The vibration exposure monitoring system of claim 1, wherein the system is operable to automatically reset a usage time for one or more of the users daily at a predetermined time.

12. The vibration exposure monitoring system of claim 1, wherein the system includes a user authentication system to verify an identity of the different users.

13. The vibration exposure monitoring system of claim 1, wherein the system includes a transmitter for transmitting usage time of the power tool to at least one of a smart device or a computer database for logging the usage time.

14. A method of monitoring vibration exposure during use of a power tool, the method comprising:
logging an amount of time the power tool is in use for different users throughout a duration of a predetermined time period; and
signaling one of the users of the power tool when the amount of time associated with the user exceeds a predetermined threshold.

15. The method of claim 14, wherein the amount of time that the power tool is in use is related to the amount of vibration exposure experienced by the users of the power tool.

16. The method of claim 14, wherein the predetermined threshold is a first predetermined threshold, and wherein the method further comprises signaling one of the users of the power tool when the amount of time associate with the user exceeds a second predetermined threshold greater than the first predetermined threshold.

17. The method of claim 16, further comprising deactivating the power tool upon reaching the second predetermined threshold.

18. The method of claim 14, further comprising resetting a usage time for one or more of the users.

19. The method of claim 14, further comprising authenticating an identity of the different users.

20. The method of claim 14, further comprising transmitting usage time of the power tool to at least one of a smart device or a computer database for logging the usage time.
